(19) United States
(12) Patent Application Publication
(10) Pub. No.: US 2024/0391044 A1
(43) Pub. Date: Nov. 28, 2024

(54) MACHINE TOOL

(71) Applicant: FUJI CORPORATION, Chiryu (JP)

(72) Inventors: Yuki ITO, Chiryu-shi (JP); Yuta KAZAMA, Toyota-shi (JP)

(73) Assignee: FUJI CORPORATION, Chiryu (JP)

(21) Appl. No.: 18/291,844

(22) PCT Filed: Sep. 1, 2021
(86) PCT No.: PCT/JP2021/032152

§ 371 Date: Jan. 24, 2024

(51) Int. Cl. B23Q 15/12

(52) U.S. Cl. CPC B23Q 15/12

(57) ABSTRACT

A machine tool suppresses the occurrence of erroneous operation on machining devices when a display operation device receives operations for the multiple machining devices. A control device of the machine tool displays a first operation section and a switching button on the display operation device. The first operation section is an operation section configured to receive operation instructions for a first machining device. The switching button is a button configured to switch a state in which the first operation section is displayed on the display operation device to a state in which a second operation section configured to receive operation instructions for a second machining device is displayed on the display operation device. The control device displays the first operation section and the switching button on the display operation device in a direction and an order in which the first machining device and the second machining device are arranged.

### TECHNICAL FIELD

The present disclosure relates to a machine tool including multiple machining devices.

### BACKGROUND ART

Conventionally, various machine tools including multiple machining devices for executing machining on a workpiece have been proposed. For example, a grinding machine of the following Patent Literature 1 includes two grinding wheel heads, a left grinding wheel head and a right grinding wheel head. The grinding machine is connected to an HMI (human machine interface) via a CNC (numerical control device) and a network. When the button of a character “L” displayed on the display screen is operated, the HMI displays information related to the left grinding wheel head on the display screen, and when the button of a character “R” is operated, the HMI displays information related to the right grinding wheel head on the display screen.

### PATENT LITERATURE

Patent Literature 1: JP-A-2000-330615 (paragraphs 0017 and FIG. 4)

### BRIEF SUMMARY

### Technical Problem

In the above-described grinding machine, the information of the left and right grinding wheel heads is displayed on the HMI, and the information of the left grinding wheel head or the right grinding wheel head is displayed according to the operation on the selection button displaying the characters “L” and “R”. However, for example, when the left grinding wheel head and the right grinding wheel head have the same or similar configuration, the information screen of the left grinding wheel head and the information screen of the right grinding wheel head have similar screen configurations. As a result, a user may erroneously recognize which of the two grinding wheel heads the information, the operation buttons, and the like displayed on the display screen belongs to. Therefore, there is a possibility that an unintended grinding wheel head is erroneously operated, for example, the right grinding wheel head is operated when the left grinding wheel head is intended to be operated.

The present disclosure has been made in view of the above problem, and an object of the present disclosure is to provide a machine tool capable of suppressing the occurrence of erroneous operation on machining devices when a display operation device receives operations for the multiple machining devices.

### Solution to Problem

In order to solve the above problem, the present description discloses a machine tool including: a first machining device configured to execute machining on a workpiece; a second machining device configured to execute machining on a workpiece and arranged side by side with the first machining device; a display operation device; a control device configured to control the first machining device and the second machining device, and display information related to the first machining device and the second machining device on the display operation device, in which the control device is configured to display a first operation section and a switching button on the display operation device, the first operation section is an operation section configured to receive operation instructions for the first machining device, the switching button is a button configured to switch from a state in which the first operation section is displayed on the display operation device to a state in which a second operation section configured to receive operation instructions for the second machining device is displayed on the display operation device, and the control device is configured to display the first operation section and the switching button on the display operation device in a direction and an order in which the first machining device and the second machining device are arranged.

### Advantageous Effects

According to the machine tool of the present disclosure, the first operation section configured to receive operation instructions for the first machining device and the switching button configured to switch to the state of receiving operation instructions for the second machining device are displayed in the same direction and order as the actual arrangement of the first and second machining devices in the machine tool. Accordingly, a user who views the display operation device can visually recognize the first machining device and the first operation section, and the second machining device and the switching button in association with each other. Therefore, the occurrence of erroneous operation by the first operation section or the second operation section can be suppressed.

### BRIEF DESCRIPTION OF DRAWINGS

FIG. 1 is a perspective view of a machine tool according to the present embodiment as viewed from a front side.

FIG. 2 is a block diagram of the machine tool.

FIG. 3 is a diagram showing a display screen of a touch panel and an operation screen of the left main spindle device.

FIG. 4 is a diagram showing a display screen of the touch panel and an operation screen of the right main spindle device.

FIG. 5 is a diagram showing an operation screen that simultaneously displays both of two operation section display areas.

FIG. 6 is a perspective view of a machine tool of another example as viewed from a front side.

### DESCRIPTION OF EMBODIMENTS

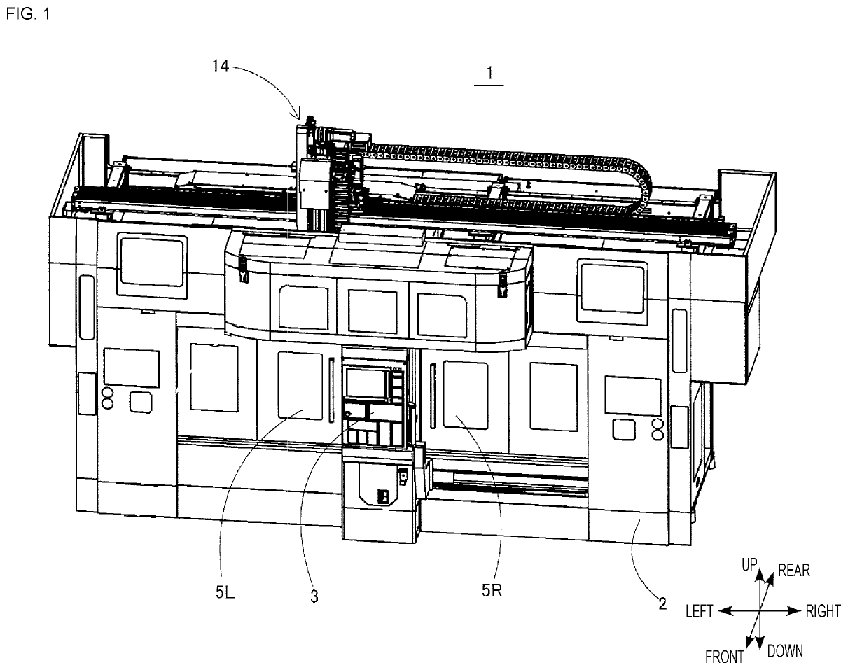

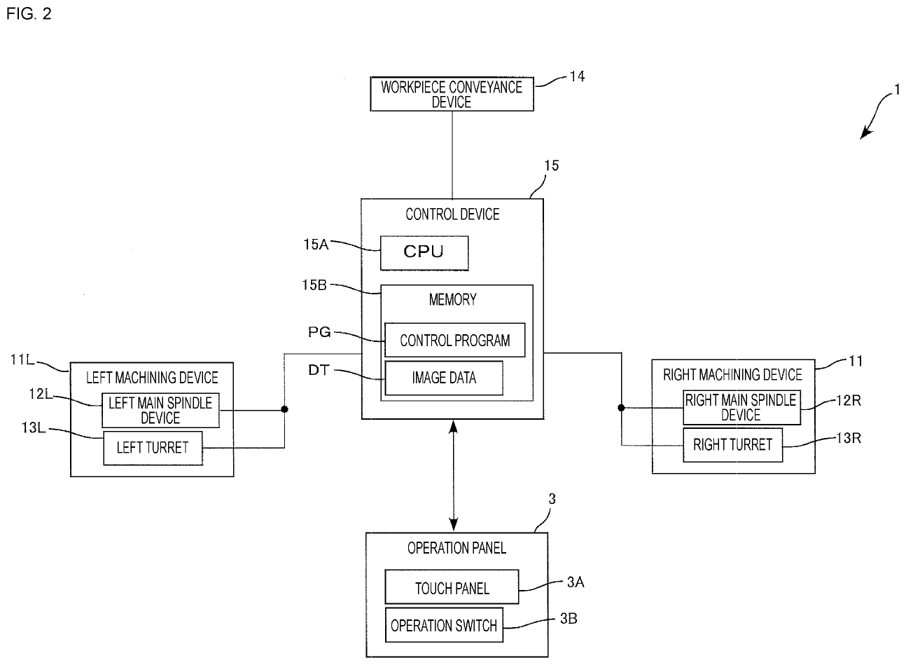

Hereinafter, an embodiment of a machine tool of the present disclosure will be described in detail with reference to the accompanying drawings. FIG. 1 is a perspective view of machine tool 1 of the present embodiment as viewed from a front side. FIG. 2 shows a block diagram of machine tool 1. In the following description, as shown in FIG. 1, with reference to a direction in which machine tool 1 is viewed from the front, a direction that is a machine width direction and is horizontal to an installation surface of a device is referred to as a left-right direction, a direction that is parallel to the installation surface of the device and is perpendicular to the left-right direction is referred to as a front-rear direction, and a direction that is perpendicular to the left-right direction and the front-rear direction is referred to as an up-down direction. In the following description, a character “L” is generally added to a sign related to the device disposed on a left side of machine tool 1, and a character “R” is added to a sign related to the device disposed on a right side of machine tool 1.

### (Configuration of Machine Tool 1)

As shown in FIGS. 1 and 2, a front face of machine tool 1 is covered with device cover 2, and operation panel 3 is provided in the center of a front surface of the tool. Device cover 2 is provided with left front door 5L and right front door 5R on both left and right sides of operation panel 3. Left and right front doors 5L and 5R are, for example, slide doors, and can access a machining space behind the doors by opening the doors.

As shown in FIG. 2, machine tool 1 includes left machining device 11L, right machining device 11R, workpiece conveyance device 14, and control device 15 in addition to operation panel 3. Left machining device 11L and a machining space for left machining device 11L are provided behind left front door 5L. Left machining device 11L is, for example, a turret-type lathe, and includes left main spindle device 12L and left turret 13L. Left main spindle device 12L includes, for example, multiple jaws (sub jaws and master jaws) that chuck a workpiece and the like, and grips the workpiece and rotates the workpiece about an axis. Left turret 13L has a tool rest to which multiple tools (rotating tool or cutting tool) are attachable, and executes tool indexing. Left turret 13L executes machining (cutting, drilling, or the like) on the workpiece gripped by left main spindle device 12L by the indexed tool. A user checks the machining state of the workpiece and exchanges the deteriorated tool through left front door 5L.

Further, right machining device 11R and a machining space for right machining device 11R are provided behind right front door 5R. Accordingly, in machine tool 1, left front door 5L (left machining device 11L), operation panel 3, and right front door 5R (right machining device 11R) are arranged side by side in order from the left when viewed from the front (forward). Right machining device 11R has the same configuration as left machining device 11L. Therefore, in the description of right machining device 11R, the description of the parts having the same configuration as those of left machining device 11L will be omitted. Right machining device 11R includes right main spindle device 12R and right turret 13R. The main spindle of right main spindle device 12R faces (opposes) the main spindle of left main spindle device 12L of left machining device 11L in the left-right direction, for example. Accordingly, left and right machining devices 11L and 11R are so-called facing biaxial-type lathes. Right machining device 11R executes machining on the workpiece gripped by right main spindle device 12R with the tool of right turret 13R. Right machining device 11R may execute machining on a workpiece different from the workpiece for left machining device 11L, or may execute machining of a previous process or a subsequent process of the machining of left machining device 11L.

In the present disclosure, as described above, the same configuration refers to a configuration in which the same type of device or the same type of tool can be attached even when the directions of the main spindle and the tool are different (even if it is symmetrical in the left-right direction). In addition, right machining device 11R need not have the same configuration as left machining device 11L. For example, at least one of left machining device 11L and right machining device 11R may be another type of machining device, such as a machining center. Machine tool 1 may include a machining center in addition to left machining device 11L and right machining device 11R. That is, machine tool 1 may include three or more machining devices.

Workpiece conveyance device 14 is, for example, a gantry type conveyance device, and executes delivery of a workpiece between left and right machining devices 11L and 11R, the machine tools at the front stage and the rear stage, and the like. Workpiece conveyance device 14 is attached to the upper part of machine tool 1, and a chuck (not shown) that grips a workpiece is made movable in the left-right direction and the up-down direction. Operation panel 3 is provided in the center of the front face of device cover 2 and includes touch panel 3A and operation switch 3B (see FIG. 2). Operation panel 3 receives operation input from a user to touch panel 3A or operation switch 3B, and outputs signals according to the received operation input to control device 15. Operation panel 3 changes the display content of touch panel 3A based on the control of control device 15. As touch panel 3A, various types of touch panels such as a capacitive touch panel and a resistive touch panel can be adopted. Touch panel 3A is an example of a display operation device of the present disclosure. The display operation device of the present disclosure is not limited to the touch panel, and may include a display screen such as a liquid crystal display or an organic EL display, and a push button or a hardware key for selecting an item (first operation section or switching button of the present disclosure) displayed on the display screen. That is, the display operation device may be configured such that a user operates a hardware key or the like provided separately from the display screen while viewing the display screen.

As shown in FIG. 2, control device 15 of machine tool 1 includes CPU 15A and memory 15B, and is a processing device mainly including a computer. Memory 15B includes, for example, RAM, ROM, a flash memory, and the like. Control device 15 is electrically connected to each device (left machining device 11L, or the like) to be able to control each device. Various control programs PG are stored in memory 15B. Control program PG includes, for example, an NC program for controlling the operation of each of left and right machining devices 11L and 11R in the machining the workpiece, a program for controlling the operation of workpiece conveyance device 14, and the like.

Control device 15 controls the operations of left and right machining devices 11L and 11R, and displays information related to left and right machining devices 11L and 11R on touch panel 3A. Image data DT is stored in memory 15B. Image data DT is data of an image displayed on touch panel 3A, and for example, is data of an operation screen that receives operation input to left main spindle device 12L. For example, control device 15 reads an image according to the operation input to touch panel 3A or operation switch 3B from image data DT and displays the image on touch panel 3A.

### (Configuration of Operation Screen and Change of Display)

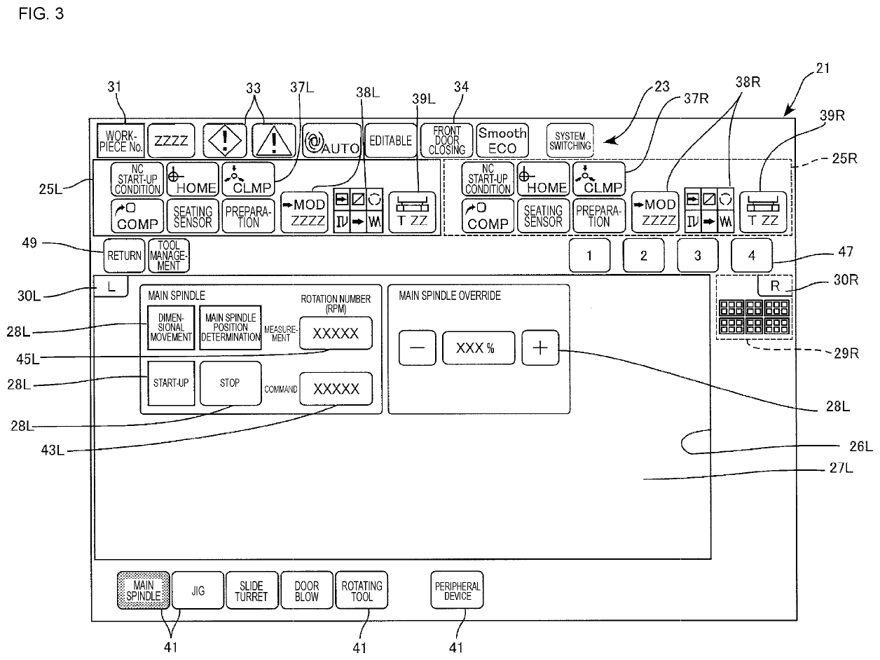

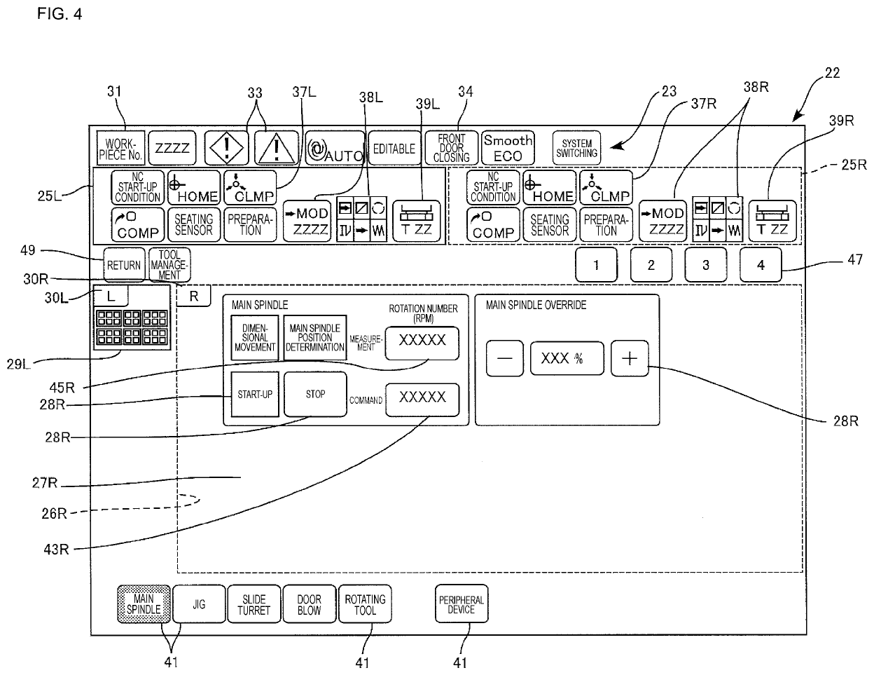

Next, the configuration of the operation screen displayed on touch panel 3A and the process of changing the display of the operation screen will be described. FIG. 3 is an example of a display screen displayed on touch panel 3A, and shows operation screen 21 on which operation buttons 28L that receive operation instructions for left main spindle device 12L are displayed. As shown in FIG. 3, main body state display section 23, state display sections 25L and 25R, operation section display area 27L, right switching button 29R, and the like are displayed on operation screen 21. Control device 15 displays operation screen 21 on touch panel 3A according to a predetermined operation input to touch panel 3A, or the like. The predetermined operation input here is, for example, an operation input according to the operating procedure for displaying operation buttons 28L on touch panel 3A. The screen configuration shown in FIG. 3 and FIG. 4 to be described later is an example, and can be appropriately changed according to the configuration or the like of the device of machine tool 1.

Main body state display section 23 is displayed at the top of operation screen 21, and displays multiple pieces of information and operation buttons. Control device 15 receives operation instructions to change operations of left machining device 11L, right machining device 11R, workpiece conveyance device 14, and the like via touch panel 3A. For example, in any state in which a screen that receives operation instructions for each device such as left machining device 11L is displayed on touch panel 3A, control device 15 constantly displays information that needs to be conveyed to a user as information of machine tool 1 and operation buttons for operations to be received on main body state display section 23. In the example shown in FIG. 3, workpiece NO button 31 that displays workpiece NO showing the type (product number) of the machining target workpiece is displayed on main body state display section 23. Control device 15 receives a change of workpiece NO according to an operation input to workpiece NO button 31. In main body state display section 23, warning information 33 that displays occurrence of an error or a failure, door information 34 that displays opening and closing of left and right front doors 5L and 5R, and the like are displayed. Accordingly, information such as workpiece NO or a warning, which are frequently checked by a user and operation buttons that are frequently executed by a user can be constantly displayed on main body state display section 23 to inform a user. Control device 15 need not constantly display main body state display section 23, and may change the display contents of main body state display section 23 according to the display of the operation screen of each device of left machining device 11L, right machining device 11R, and workpiece conveyance device 14.

State display sections 25L and 25R are displayed below main body state display section 23 and arranged side by side in the left-right direction. Each of state display sections 25L and 25R has a rectangular shape elongated in the left-right direction and has the same size. State display section 25L is surrounded by, for example, a red straight line. State display section 25R is surrounded by a blue straight line. Accordingly, control device 15 displays state display section 25L of left machining device 11L by surrounding state display section 25L of left machining device 11L with red on the left side, and displays state display section 25R of right machining device 11R by surrounding state display section 25R of right machining device 11R with blue on the right side. In FIG. 3, the blue outer frame of state display section 25R is shown by a dashed line for convenience of description. The same applies to right switching button 29R described later.

Information related to the state of left machining device 11L is displayed in state display section 25L. For example, state display section 25L displays chuck state information 37L showing whether left main spindle device 12L is chucking (clamping) the workpiece or releasing the clamping. In addition, mode information 38L that displays information related to the NC mode of left machining device 11L (selected NC mode) is displayed on state display section 25L. The NC mode is, for example, a control mode of NC control, and includes an automatic operation mode in which NC programs are read and automatically executed in order, a manual operation mode in which a user performs a manual operation, an MDI operation mode in which NC programs are executed line by line, an edit mode in which editing of NC programs is received, and the like. Further, turret number information 39L showing a holder number of a tool indexed (used for machining) by left turret 13L is displayed on state display section 25L.

State display section 25R is displayed on the right side of state display section 25L. State display section 25R displays information relating to the state of right machining device 11R and having the same items of information as state display section 25L. Therefore, in the description of state display section 25R, description of the configuration similar to the configuration of state display section 25L will be appropriately omitted. State display section 25R displays chuck state information 37R of right main spindle device 12R, mode information 38R related to the NC mode of right machining device 11R, and turret number information 39R of right turret 13R.

Operation section display area 27L and right switching button 29R are displayed below state display sections 25L and 25R. Operation section display area 27L is a rectangular area surrounded by area frame 26L. Area frame 26L is, for example, a linear frame of red (an example of a first color of the present disclosure), and is a rectangular frame elongated in the left-right direction. Multiple operation buttons 28L and the like are arranged in operation section display area 27L surrounded by area frame 26L. At the upper left corner of area frame 26L and operation section display area 27L, character 30L corresponding to “L” that indicates the left side is displayed. For example, character 30L is displayed in white-outline character L on a red background.

Right switching button 29R is displayed on the right side of operation section display area 27L and has a substantially square shape. Right switching button 29R is surrounded by, for example, a line of blue (an example of a second color of the present disclosure). At the upper right corner of right switching button 29R, character 30R corresponding to “R” that indicates the right side is displayed. For example, character 30R is displayed in white-outline character R on a blue background. Right switching button 29R is a button that switches from a state in which operation buttons 28L are displayed on touch panel 3A to a state in which operation buttons 28L (operation section display area 27L) that receive operation instructions for right machining device 11R shown in FIG. 4 are displayed on touch panel 3A. Control device 15 displays operation buttons 28L (operation section display area 27L) and right switching button 29R in the direction (in the present embodiment, left-right direction) and the order (left and right order) in which left and right machining devices 11L and 11R are arranged.

Accordingly, control device 15 displays operation buttons 28L that operate left machining device 11L on the left side and right switching button 29R that switches to the operation of right machining device 11R on the right side to have the same arrangement as the actual arrangement of the machining devices of machine tool 1. Similarly to state display sections 25L and 25R, control device 15 displays operation section display area 27L and right switching button 29R such that operation section display area 27L that receives operation instructions for left machining device 11L is surrounded by red area frame 26L and right switching button 29R that switches to the operation of right machining device 11R is surrounded by blue.

Multiple selection buttons 41 are displayed below operation section display area 27L. Each of multiple selection buttons 41 is a button for changing the device that is the operation target of operation button 28L, in other words, for changing the type of operation buttons 28L displayed in operation section display area 27L. For example, characters of a main spindle, a jig, a slide turret, a door blow, a rotating tool, and a peripheral device are displayed in order from the left on each of multiple selection buttons 41. Control device 15 displays operation buttons 28L related to a device touched (selected) by a user among multiple selection buttons 41 in operation section display area 27L.

Operation screen 21 in FIG. 3 shows a state in which main spindle selection button 41 is selected (see hatching in FIG. 3) and operation buttons 28L that operate left main spindle device 12L are displayed in operation section display area 27L. For example, when operation button 28L of the character “start-up” in operation section display area 27L is touch-operated, control device 15 rotates left main spindle device 12L. Control device 15 rotates left main spindle device 12L based on the number of rotations set in setting field 43L in operation section display area 27L, and displays the number of rotations actually measured by an encoder, or the like in display field 45L. When operation button 28L of the character “stop” is touch-operated, control device 15 stops the rotation of left main spindle device 12L. Accordingly, a user can control the operation of left main spindle device 12L by operating operation buttons 28L, and can cause left main spindle device 12L to execute a machining operation, a maintenance operation, a confirmation operation when an error occurs, and the like. Operation button 28L and setting field 43L are examples of a first operation section of the present disclosure. Accordingly, the “first operation section configured to receive an operation instruction for the first machining device” of the present disclosure is not limited to a determination button that determines the operation content such as operation button 28L, and is a concept including setting field 43L for inputting a setting (parameter, or the like) that determines the operation of left machining device 11L.

Multiple page selection buttons 47 are displayed between operation section display area 27L and right switching button 29R and state display section 25R in the up-down direction. When the number of operation buttons 28L and the like to be displayed is large for the device or the like selected by selection button 41, control device 15 displays operation buttons 28L and the like in multiple pages. Multiple page selection buttons 47 are buttons used to select pages from among the divided multiple pages. In addition, return button 49 or the like for returning to the display of the previous page is displayed between operation section display area 27L and state display section 25L in the up-down direction.

Control device 15 displays operation buttons 28L and the like of devices selected by a user among multiple selection buttons 41 in operation section display area 27L. For example, when selection button 41 of “jig” is touch-operated, control device 15 displays operation buttons 28L for operating the sub jaw or the like in operation section display area 27L. For example, when selection button 41 of “rotating tool” is touch-operated, control device 15 displays operation buttons 28L for operating the rotating tool of left turret 13L in operation section display area 27L. In this manner, control device 15 executes control for left machining device 11L according to the user's operation input on operation screen 21.

Further, for example, in a state where operation screen 21 in FIG. 3 is shown on touch panel 3A, when a touch operation of right switching button 29R is detected, control device 15 displays a screen for operating right machining device 11R on touch panel 3A. FIG. 4 shows operation screen 22 in which operation buttons 28R that receive operation instructions for right main spindle device 12R are displayed in operation section display area 27R as an example of a screen that receives operation instructions for right machining device 11R.

FIG. 4 is an example of a display screen displayed on touch panel 3A, and shows operation screen 22 that displays operation buttons 28R that receive operation instructions for right main spindle device 12R of right machining device 11R. Operation screen 22 has substantially the same configuration as operation screen 21 in FIG. 3. Therefore, in the description of operation screen 22, description of a part similar to the part of operation screen 21 will be omitted. Similarly to operation screen 21 in FIG. 3, main body state display section 23 and state display sections 25L and 25R are displayed at the top of operation screen 22. Operation section display area 27R is displayed below state display sections 25L and 25R. In operation section display area 27R, similarly to operation section display area 27L, operation buttons 28R that operate right main spindle device 12R, setting field 43R, and display field 45R are displayed.

Left switching button 29L is displayed on the left side of operation section display area 27R. State display section 25L of operation screen 22 is surrounded by a red straight line, and state display section 25R is surrounded by a blue straight line. Left switching button 29L that switches to the operation of left machining device 11L is surrounded by a red straight line, and area frame 26R of operation section display area 27R is a blue straight line frame (see the dashed line in FIG. 4). Character 30L corresponding to “L” is displayed at the upper left corner of left switching button 29L, and character 30R corresponding to “R” is displayed at the upper left corner of operation section display area 27R. Characters 30L and 30R in FIG. 3 and FIG. 4 are displayed in the same display manner.

The colors of area frame 26L and right switching button 29R shown in FIG. 3, left switching button 29L and area frame 26R shown in FIG. 4, and state display sections 25L and 25R shown in FIGS. 3 and 4 are not limited to red and blue. For example, the outer frame of state display section 25L and area frame 26L may have different colors (red, yellow, and the like). Area frame 26L and right switching button 29R may have the same color. The outer frames of state display sections 25L and 25R may have the same color. In addition, characters 30L and 30R need not be displayed, that is, the left and right identification information need not be displayed as characters. Similarly to character 30R in right switching button 29R shown in FIG. 3, character 30R may be displayed at the upper right corner of area frame 26R in FIG. 4. That is, the display positions of character 30L corresponding to “L” of area frame 26L and left switching button 29L may be the same, and the display positions of character 30R corresponding to “R” in right switching button 29R and area frame 26R may be the same.

When left switching button 29L is touch-operated in a state where operation section display area 27R (operation buttons 28R, and the like) is displayed, control device 15 displays a screen (operation screen 21, and the like in FIG. 3) that receives operation instructions for right machining device 11R on touch panel 3A. As described above, control device 15 displays operation buttons 28L and the like according to the selection of selection button 41 or page selection button 47 in operation section display area 27L. For example, when right switching button 29R or left switching button 29L is operated, control device 15 displays a screen selected by selection button 41 or the like on the screen before switching. For example, even if right switching button 29R is touch-operated in a state where selection button 41 of “spindle” shown in FIG. 3 is selected, and then selection button 41 of “rotating tool” is selected on the operation screen of right machining device 11R shown in FIG. 4, when left switching button 29L is touch-operated, control device 15 displays operation screen 21 in which main spindle selection button 41 before switching is selected. That is, control device 15 maintains and displays the previous display state.

Alternatively, control device 15 may reflect the selection of selection button 41 or page selection button 47 that is selected in switching, on the screen after switching. For example, when left switching button 29L is operated after right switching button 29R is operated from the state of displaying operation screen 21 in FIG. 3 to display operation screen 22 shown in FIG. 4 and selection button 41 of “rotating tool” is selected, control device 15 may change the selection item from the main spindle to the rotating tool and display operation buttons 28L of the rotating tool of left turret 13L. That is, the display items of operation section display areas 27L and 27R may be synchronized before and after the switching.

Here, as described above, in machine tool 1, left machining device 11L and right machining device 11R have the same configuration, and when the same selection button 41 or page selection button 47 is selected, operation buttons 28L and 28R, and the like of the same items are displayed in operation section display areas 27L and 27R. Therefore, when a user executes an operation on touch panel 3A, the user may erroneously use the operation target machining device. When an operation error occurs, there is a concern that the main spindle device or the like which need not be stopped may be stopped, so that productivity decreases. In addition, even when the configurations of left and right machining devices 11L and 11R are not completely the same but are similar to each other, operation buttons 28L and 28R and the like have similar configurations, so that there is a concern that an operation error may occur.

Control device 15 specifies which of the machining devices, either left machining device 11L or right machining device 11R, is targeted by operation buttons 28L and 28R and the like by displaying characters 30L and 30R corresponding to “L” and “R”. In addition, control device 15 displays operation buttons 28L and right switching button 29R in a direction and an order in which left and right machining devices 11L and 11R are arranged. Since touch panel 3A is provided at the center of the front face of device cover 2 as shown in FIG. 1, a user standing in front of touch panel 3A can recognize the arrangement of left and right machining devices 11L and 11R and the arrangement of operation buttons 28L and right switching button 29R in association with each other as viewed from the front, and can intuitively recognize that operation buttons 28L displayed on the left of right switching button 29R are operation buttons for left machining device 11L. As a result, the occurrence of erroneous operation can be suppressed.

In addition, control device 15 displays operation section display area 27L in FIG. 3 by surrounding operation section display area 27L with red area frame 26L (an example of a first color of the present disclosure), and displays operation section display area 27R in FIG. 4 by surrounding operation section display area 27R with blue area frame 26R (an example of a second color of the present disclosure). Then, control device 15 displays right switching button 29R that switches to the operation of right machining device 11R by surrounding right switching button 29R with the same blue color as area frame 26R. Accordingly, before and after a user operates right switching button 29R to perform switching, right switching button 29R and area frame 26R can be recognized in association with each other by the same color. Therefore, the occurrence of erroneous operation can be suppressed not only by considering the arrangement direction and order of operation buttons 28L and right switching button 29R, but also by color recognition.

In addition, control device 15 displays state display sections 25L and 25R on touch panel 3A in the direction and the order in which left and right machining devices 11L and 11R are arranged, that is, in order from the left. Control device 15 displays state display sections 25L and 25R at the same position with the same items regardless of whether operation buttons 28L that operate left machining device 11L or operation buttons 28R that operate right machining device 11R are displayed. Accordingly, even when maintenance or the like is executed on any of left machining device 11L or right machining device 11R, it is possible to constantly display information (such as NC control mode) for a user to be notified (information to be conveyed to a user). In other words, even when any machining device is operated, information that a user wants to know can be displayed on state display sections 25L and 25R.

Furthermore, control device 15 displays an area for displaying state display section 25L (an example of a third area of the present disclosure) by surrounding the area with the same red as area frame 26L, and displays an area for displaying state display section 25R (an example of a fourth area of the present disclosure) by surrounding the area with the same blue as right switching button 29R. In this manner, a user can recognize state display section 25L on the left side, area frame 26L, and left switching button 29L in red in association with each other. Further, a user can recognize state display section 25R on the right side, area frame 26R, and right switching button 29R in blue in association with each other. For example, when operation buttons 28L are operated, it is possible to cause a user to recognize in color that it is necessary to check state display section 25L surrounded by the same red color. It is possible to suppress the occurrence of misreading of state display sections 25L and 25R.

As shown in FIG. 3, right switching button 29R is a button smaller in size compared to operation section display area 27L displayed on the same screen (operation screen 21). The same applies to the size relationship between left switching button 29L and operation section display area 27R shown in FIG. 4. Right switching button 29R in FIG. 3 displays an image simulating the shape and arrangement of multiple operation buttons 28R, and the like shown in FIG. 4. Specifically, an image, in which operation buttons 28R, setting field 43R, display field 45R, and the like arranged in the left-right direction are arranged in multiple stages in the up-down direction, is displayed on the right switching button 29R. Similarly, an image simulating multiple operation buttons 28L and the like in FIG. 3 is displayed on left switching button 29L in FIG. 4.

Then, control device 15 displays right switching button 29R at the right end of operation screen 21 in the left-right direction in which left and right machining devices 11L and 11R are arranged. Control device 15 displays left switching button 29L at the left end of operation screen 22. With this, right switching button 29R is made as small as possible and displayed at the end of the screen, so that the display area of operation section display area 27L can be made larger. In addition, by displaying image simulating operation buttons 28R, and the like on right switching button 29R, even a user who operates for the first time can intuitively recognize that right switching button 29R is a button that displays operation buttons 28R, and the like.

As described above, left and right machining devices 11L and 11R have the same configuration, and the configuration of operation buttons 28L and the like in operation section display area 27L is the same as the configuration of operation section display area 27R. In such machine tool 1, the same machining can be executed on the same type of workpiece in each of left and right machining devices 11L and 11R, so that productivity can be improved. On the other hand, when the left and right devices have the same configuration, the above-described operation error is likely to occur. Therefore, in machine tool 1 in which left and right machining devices 11L and 11R have the same configuration, in particular, a display method of arranging operation buttons 28L and right switching button 29R according to the arrangement direction and the order of the machining devices is extremely effective.

Control device 15 changes the contents of the display screen according to the operation input to selection button 41, page selection button 47, operation buttons 28L and 28R, and the like. For example, control device 15 determines a procedure or the like of the operation input of touch panel 3A based on control program PG, reads an image according to a determination result from image data DT, and displays the image on touch panel 3A. For example, as shown in FIG. 3, when the size of operation section display area 27L that displays operation buttons 28L and the like is larger than half of the display screen of touch panel 3A, control device 15 displays operation section display area 27L and right switching button 29R.

Accordingly, in image data DT, for an image in which operation section display area 27L is equal to or larger than half of the display screen, an image of right switching button 29R is set to the right of operation section display area 27L. Control device 15 may determine whether the size of operation section display area 27L is equal to or larger than half of the display screen, and determine the screen configuration of the display screen. For example, according to the operation input of touch panel 3A, when reading multiple images from image data DT and displaying the read images in combination, control device 15 may determine the size of operation section display area 27L and determine whether to display right switching button 29R.

On the other hand, depending on the amount of information to be displayed, the size of operation section display area 27L is smaller than half of the display screen. When operation buttons 28R and the like are displayed in operation section display area 27R as same as in operation section display area 27L, the size of operation section display area 27R is also smaller than half of the display screen. When operation section display areas 27L and 27R are smaller than half of the display screen, it is more efficient to display two operation section display areas 27L and 27R on the same screen and receive operation instructions for both left and right machining devices 11L and 11R than to display right switching button 29R, or the like.

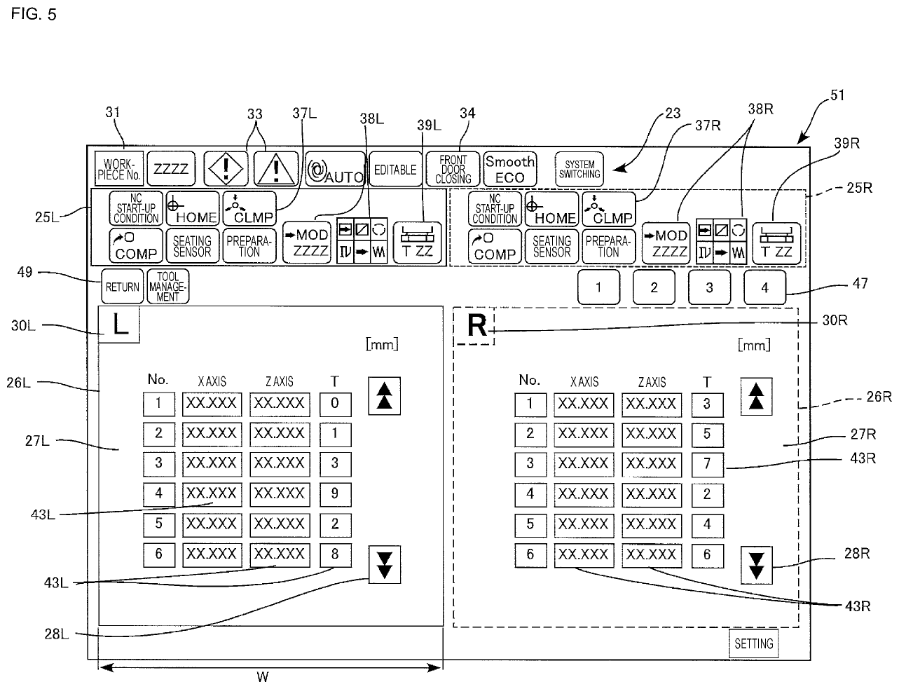

FIG. 5 shows an example of an operation screen displaying both operation buttons 28L and 28R in operation section display areas 27L and 27R simultaneously. Operation screen 51 in FIG. 5 is a screen for inputting a correction value (coordinates) of each tool. Width W of operation section display area 27L in the left-right direction in FIG. 5 is equal to or smaller than half of operation screen 51. In operation section display area 27L, NO, a correction value in the X-axis direction, a correction value in the Z-axis direction, and a tool number (holder number) of left turret 13L are displayed in order from the left. A user inputs the correction values in the X-axis direction and the Z-axis direction to setting fields 43L according to the wear of the tool. Control device 15 corrects the X-axis coordinate and the Z-axis coordinate of the target tool based on the input correction value, and corrects the position of the tool with respect to the workpiece. In addition, control device 15 displays setting fields 43L and the like of other tools that could not be displayed in operation section display area 27L according to the operation on two operation buttons 28L (buttons indicating the up-down direction) in operation section display area 27L.

Operation section display area 27R is displayed on the right side of operation section display area 27L, has the same size as operation section display area 27L, and displays setting fields 43R of the same items and the like. Operation section display area 27L is surrounded by red area frame 26L, and operation section display area 27R is surrounded by blue area frame 26R. For example, in image data DT, operation screen 51 shown in FIG. 5 is pre-stored. That is, operation screen 51 or the like having a screen configuration according to the size of operation section display area 27L or the like is pre-set in image data DT.

When receiving an operation to display operation screen 51 on touch panel 3A, control device 15 reads operation screen 51 from image data DT and displays operation screen 51. Accordingly, when the size of operation section display area 27L is equal to or smaller than half of the display screen of touch panel 3A, control device 15 can display operation buttons 28R and setting fields 43R in addition to operation buttons 28L and the setting fields 43L. In addition, control device 15 displays operation buttons 28L and 28R in the direction and the order in which left and right machining devices 11L and 11R are arranged. Further, control device 15 displays area frames 26L and 26R shown in FIG. 5 in the same red-blue color coding as area frames 26L and 26R, left switching button 29L, and right switching button 29R shown in FIGS. 3 and 4.

Accordingly, it is possible to receive operation instructions for two machining devices on one screen, such as when there are only a few display items. In addition, by using the same color coding in a case where operation buttons 28L and right switching button 29R are displayed as shown in FIG. 3 and in a case where two operation section display areas 27L and 27R are displayed as shown in FIG. 5, a user can determine the target machining device by the color even when the display as shown in FIG. 3 or the display as shown in FIG. 4 is switched and displayed. Therefore, the occurrence of erroneous operation can be suppressed.

Incidentally, touch panel 3A is an example of a display operation device. Left machining device 11L is an example of a first machining device. Right machining device 11R is an example of a second machining device. State display section 25L is an example of a first state display section. State display section 25R is an example of a second state display section. Operation buttons 28L and setting fields 43L are examples of a first operation section. Operation buttons 28R and setting fields 43R are examples of a second operation section. Operation section display area 27L is an example of a first area. Operation section display area 27R is an example of a second area.

On the contrary, when right machining device 11R is regarded as a first machining device and left machining device 11L is regarded as a second machining device, the first and second machining devices of the present disclosure are arranged in the order of right and left. In this case, operation buttons 28R and setting fields 43R are examples of the first operation section. Operation buttons 28L and setting fields 43L are examples of the second operation section.

As described above, according to the present embodiment described above, the following advantageous effects can be achieved.

In an aspect of the present embodiment, control device 15 displays operation buttons 28L and right switching button 29R in the direction and the order in which left and right machining devices 11L and 11R are arranged (see FIG. 3). With this, a user who views the display of touch panel 3A can intuitively recognize whether the screen for operating left machining device 11L is displayed or the screen for operating right machining device 11R is displayed based on the arrangement of operation buttons 28L and right switching button 29R. As a result, the occurrence of erroneous operation can be suppressed. In particular, in machine tool 1 of the present embodiment, as shown in FIG. 1, operation panel 3 (touch panel 3A) is arranged between left and right machining devices 11L and 11R in the left-right direction. Therefore, a user standing in front of touch panel 3A can more intuitively recognize that left operation buttons 28L relate to left machining device 11L on the left side of the user and right switching button 29R relates to right machining device 11R on the right side of the user.

The present disclosure is not limited to the above-described embodiment, and it is needless to say that various improvements and changes can be made without departing from the gist of the present disclosure.

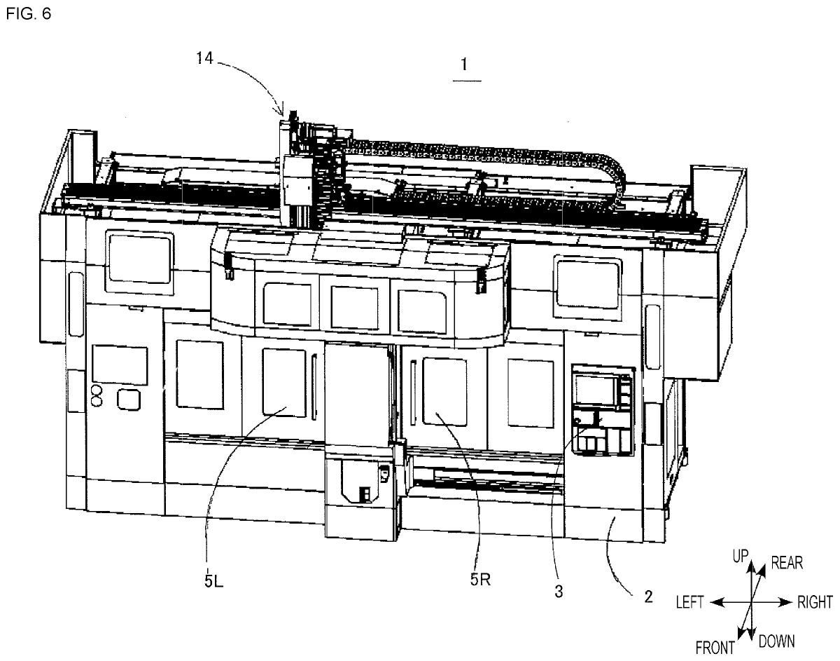

For example, in the above embodiment, as shown in FIG. 1, operation panel 3 is provided between left front door 5L (left machining device 11L) and right front door 5R (right machining device 11R) in the left-right direction; however, the configuration is not limited to this. For example, as shown in FIG. 6, left front door 5L (left machining device 11L), right front door 5R (right machining device 11R), and operation panel 3 may be provided in this order from the left. In this case as well, the occurrence of erroneous operation can be suppressed by displaying as shown in FIGS. 3 and 4 according to the arrangement of left and right machining devices 11L and 11R.

Further, operation panel 3 may be provided on a lateral side or an upper surface of device cover 2.

The direction in which left and right machining devices 11L and 11R are arranged is not limited to the left-right direction, and may be the front-rear direction or the up-down direction of machine tool 1. In this case as well, the direction, the order, the color, and the like of operation buttons 28L and right switching button 29R displayed on touch panel 3A may be set according to the direction and the order in which left and right machining devices 11L and 11R are arranged.

In the above embodiment, area frame 26L and the like are color coded, but color coding need not be used.

Further, the background of operation section display area 27L or state display section 25L may be colored instead of color coding of frames such as area frame 26L.

State display sections 25L and 25R need not be arranged in the direction (left-right direction) of left and right machining devices 11L and 11R. For example, state display sections 25L and 25R may be arranged in the up-down direction.

Right switching button 29R may be larger in size than operation section display area 27L. Image simulating operation buttons 28R need not be displayed on right switching button 29R. Further, the text such as “R system switching” may be displayed on right switching button 29R.

Right machining device 11R may have a configuration different from the configuration of left machining device 11L, for example, a machining center. Therefore, when the configuration of the machining device is different, operation buttons 28L and 28R and the like may have different configurations (items or buttons different between left and right machining devices).

The configurations of operation screens 21, 22, and 51 shown in FIGS. 3 to 5 are examples. For example, state display sections 25L and 25R may be displayed below operation section display area 27L.

Control device 15 may display operation section display areas 27L and 27R on separate screens, even if operation section display areas 27L and 27R are large enough to be displayed on the same screen as shown in FIG. 5.

Left and right machining devices 11L and 11R may have various configurations such as a horizontal lathe, a face lathe, a vertical lathe, a milling machine, and a ball machine.

### REFERENCE SIGNS LIST

1: machine tool, 3A: touch panel (display operation device), 11L: left machining device (first machining device), 11R: right machining device (second machining device), 15: control device, 25L: state display section (first state display section), 25R: state display section (second state display section), 27L: operation section display area (first area), 27R: operation section display area (second area), 28L: operation button (first operation section), 28R: operation button (second operation section), 29R: right switching button (switching button), 43L: setting field (first operation section), 43R: setting field (second operation section)

1. A machine tool comprising:
a first machining device configured to execute machining on a workpiece;
a second machining device configured to execute machining on a workpiece and arranged side by side with the first machining device;
a display operation device;
a control device configured to control the first machining device and the second machining device, and display information related to the first machining device and the second machining device on the display operation device,
wherein the control device is configured to display a first operation section and a switching button on the display operation device,
the first operation section is an operation section configured to receive operation instructions for the first machining device,
the switching button is a button configured to switch from a state in which the first operation section is displayed on the display operation device to a state in which a second operation section configured to receive operation instructions for the second machining device is displayed on the display operation device, and
the control device is configured to display the first operation section and the switching button on the display operation device in a direction and an order in which the first machining device and the second machining device are arranged.

2. The machine tool according to claim 1, wherein
the control device is configured to display a first area configured to display the first operation section by surrounding the first area with a first color, display a second area configured to display the second operation section by surrounding the second area with a second color different from the first color, and display the switching button by surrounding the switching button with the second color.

3. The machine tool according to claim 2, wherein
the control device is configured to display a first state display section configured to display a state of the first machining device and a second state display section configured to display a state of the second machining device on the display operation device, display the first state display section and the second state display section in both a state in which the first operation section is displayed and a state in which the second operation section is displayed, and display the first state display section and the second state display section on the display operation device in the direction and the order in which the first machining device and the second machining device are arranged.

4. The machine tool according to claim 3, wherein
the control device is configured to display a third area configured to display the first state display section by surrounding the third area with the first color, and display a fourth area configured to display the second state display section by surrounding the fourth area with the second color.

5. The machine tool according to claim 1, wherein
the switching button is a button smaller in size compared to a first area that is displayed on the same screen and displays the first operation section, and is a button simulating the second operation section, and
the control device is configured to display the switching button at an end of the display operation device in a direction in which the first machining device and the second machining device are arranged.

6. The machine tool according to claim 1, wherein
the second machining device has the same configuration as the first machining device, and
the first operation section has the same configuration as the second operation section.

7. The machine tool according to claim 1, wherein
the control device is configured to
display the first operation section and the switching button on the display operation device and display the first operation section and the switching button in color coding, in a case where a size of a first area configured to display the first operation section is larger than half of a display screen of the display operation device, and
display the second operation section in addition to the first operation section on the display operation device, display the first operation section and the second operation section on the display operation device in the direction and the order in which the first machining device and the second machining device are arranged, and display the first operation section and the second operation section in the same color coding as the first operation section and the switching button, in a case where a size of the first area configured to display the first operation section is equal to or smaller than half of the display screen of the display operation device.

8. The machine tool according to claim 1, wherein
the display operation device is provided on a front face of a device cover of the machine tool,
the first machining device and the second machining device are arranged side by side in a left-right direction in an order of the first machining device and the second machining device, in a case where the machine tool is viewed from a front, and
the control device is configured to display the first operation section on a left side of the display operation device and display the switching button on a right side of the display operation device.
